(19) United States
(12) Patent Application Publication
(10) Pub. No.: US 2004/0028503 A1
(43) Pub. Date: Feb. 12, 2004

(54) Self-locking permanent internal fastening system

(76) Inventor: Christopher Charles, Bloomingdale, IL (US)

Correspondence Address: CHRISTOPHER C. POSTEL, 195 EVCLID AVE, BLOOMINGDALE, IL, 60108, US

(21) Appl. No.: 10/216,153

(22) Filed: Aug. 12, 2002

(51) Int. Cl. F16B 19/00

(52) U.S. Cl. 411/510

(57) ABSTRACT

A two-part fastener includes a male component equipped with parallel angled ridges and a female component equipped with parallel complementary angled ridges which engage in a self-locking manner during fastener installation for permanent internal one-way attachment of elements or body halves. The male and female fastener components are integrally fabricated within the bodies, are externally inserted, or in combination.

### CROSS-REFERENCE TO RELATED APPLICATIONS

Not applicable.

### BACKGROUND—FIELD OF INVENTION

The present invention relates generally to two-part fasteners, and more particularly to permanent internal self-locking fasteners for attaching two or more members or bodies together without the use of tools or adhesive bonding agents.

### BACKGROUND—DESCRIPTION OF PRIOR ART

Reusable fasteners are commonly used for connecting two members or bodies together. Typical fasteners of this type are the common threaded bolt with nut or the common screw. In both cases, a tool or tools are required to insure the two members are joined securely.

Adhesives are also often used for connecting members together. An adhesive joint is generally more permanent as failure or delamination of the member substrates can result if the joint is intentionally separated.

In addition, combination of adhesives and fasteners can be used, depending on the members and design. The combination is often used when critical members that cannot release (for various reasons) facilitate the need for a redundant or back-up fastening method.

In instances where tools are not available or desired, a self-locking fastener would allow the joining of members without conventional fasteners and tools. Anderson in U.S. Pat. No. 5,775,863 and later Scheiss in U.S. Pat. No. 5,980,180 narrowly addressed the need, for example, with a self-locking fastener for applications such as installing signs on signposts. A clamp-like clip device is used to secure the external fastener in place. However, this approach addresses applications the fastener is removable, the location of fastening is always external, and the necessary access and space for facilitating clip action is available. There are numerous applications where internal fastening is either desired or the only option. Regulation, proprietary nature, tamper-proof requirements and the like can necessitate permanency of the attachment.

In the case of consumer products, for example, plastic bodies consisting of two body halves are often assembled with a multitude of internal parts. Consumer products, especially those for children, may contain small or hazardous parts. It is imperative that the plastic bodies remain joined and prevent any parts from releasing. In the case of products for children, the use of fasteners poses an additional hazard of the fastener releasing either by itself or in concert with the release of internal parts. If used to replace fasteners, adhesives or solvent bonding on children's products pose the additional hazard of toxicity. The combination of adhesive and fasteners can provide some redundancy for the release of internal parts, but still poses the hazards of toxicity and release of the fastener.

The use of screws as a fastener in plastic materials is common. Continuing with the example of a plastic body, the two halves are joined and a screw is inserted in one body half. An internal post in the second body half is the attachment point for the screw. Tightening the screw results in the two halves mating securely and having an appropriate joint strength. However, several problems can arise when using screws in plastic, resulting in low attachment strength: (a) the screw can be over-torqued and strip the threads in the post hole; (b) the screw can be over-torqued and shear in half; (c) a screw with a diameter too small or length too short for adequate contact with the post hole; (d) a screw with a diameter too large for the post hole, creating stress crazing or cracking. Finally, the skill and judgement of the worker greatly affects the quality of the resulting assembly.

Bonding plastic materials with adhesive agents is common practice. However, there are several factors which result in variable joint strength or make adhesive use altogether unattractive: (a) working life of adhesive; (b) catalyst/base ratios of two-part adhesives; (c) volatile level and ambient working temperature; (d) worker skill and consistency of application; (e) carcinogenic materials in adhesive formulations giving rise to toxicity concerns; (e) type of plastic.

To minimize toxicity issues with adhesive formulations, bonding with a solvent can be performed as an alternative. Solvent bonding involves the use of an appropriate solvent applied to specific post and posthole locations on one or both body halves. The solvent temporarily and locally dissolves the base plastic. When the body halves are joined and the solvent evaporates, the plastic pieces are integrally bonded at the local locations with the base plastic material. Although solvent bonding minimizes toxicity issues, there are several factors which result in variable joint strength: (a) highly dependent on the solvent used; (b) the amount of time from solvent application to mating of the surfaces; (c) ambient temperatures during application; (d) worker skill and diligence of application. In addition, solvent bonding also limits the available plastic materials that can be used.

Self-locking fastening concepts have been explored in numerous patents. For example, U.S. Pat. Nos. 4,094,352, 4,294,300, 4,657,459 and 5,080,545 relate to teeth or serrations on the bearing surfaces to prevent a threaded fastener from loosening; U.S. Pat. No. 4,089,248 relates to a self-locking fastener with a collapsable feature as a threaded screw is inserted and then removed; U.S. Pat. No. 4,236,280 relates to a flexible plastic tie-strap; U.S. Pat. No. 5,775,863, as previously cited, approaches self-locking with a clip device for external fastening applications.

There is a need for a fastening method that will allow internal, permanent fastening of members quickly and easily without the use of tools or adhesive materials. In the area of consumer products, especially those intended for children, a method of fastening that eliminates the use of screws, adhesives, solvents, and is independent of worker skill is particularly desired.

### SUMMARY OF THE INVENTION

In accordance with the present invention, a fastening system comprises a male and female component with a plurality of ridges, one complimentary to the other, shaped to allow one-way entrapment to provide a self-locking permanent, internal attachment of members.

Objects and Advantages

Accordingly, besides the objects and advantages of the fastener described in my above patent, several objects and advantages of the present inventions are:

(a) to provide a fastening system for internal fastening applications

(b) to provide a fastening system that eliminates the use of screws, adhesives and solvents

(c) to provide a fastening system that eliminates the use of toxic chemicals and chemicals that may cause allergic reaction when used for consumer products, especially those intended for use by children.

(d) to provide a fastening system which consists of a two-part fastener that can either be integrally molded, a separate fastener, or a combination of the two.

(e) to provide a fastening system which, by design, allows an automatic locking feature that will provide a permanent joint between two or more components.

(f) to provide a fastening system which eliminates most or all operator skill requirements

(g) to provide a fastening system for designs intended to be tamper-proof.

(h) to provide a fastening system for designs intended to prevent small or critical components from releasing and posing a safety risk to the consumer, especially those intended for use by children.

Further objects and advantages are to provide a fastening system which can be easily manufactured from a variety of materials which, because of limitations when using other fastening techniques, have not been previously available as a choice; which can be used in conjunction with different embodiements to provide redundant fastening; and which can be used to protect proprietary or hazardous components. These and other objectives and advantages of the invention will become more apparent from a consideration of the ensuing detailed description and accompanying drawings.

### DRAWING FIGURES

FIG. 1 shows the preferred embodiment of attaching two body halves with an integrally molded fastener in both perspective and side views.

FIG. 2 shows an alternate embodiment configuration wherein the attachment components are spread apart.

FIG. 3 shows alternate concepts for the attachment design

FIG. 4 illustrates combinations of external and integrally molded fastening

FIG. 5 shows a round external fastener concept, isometric view

FIG. 6 shows external fastener with round cross-sectional shape

FIG. 7 shows external fastener with triangular cross-sectional shape

FIG. 8 shows an alternate embodiment configuration wherein integral attachment is along edge

FIG. 9 illustrates an alternate embodiment for attaching a plastic component to a fabric

FIG. 10 illustrates an alternate embodiment using a flexible plastic

REFERENCE NUMERALS IN DRAWINGS

| | |
|---|---|
| 10 Male component | 12 Ridges on male component |
| 14 Female component | 16 Complementary ridges on female component |
| 18 Legs on female component | 20 Body half |
| 22 Complementary body half | 24 Opening in body half |
| 26 Opening in complementary body half | 28 Lip on female external fastener head |
| 30 Extemal groove on complementary body half | 32 Lip on male external fastener head |
| 34 Extemal groove on body half | 38 Alignment tab |
| 40 Angled surface, male component | 41 Draft angle, male component |
| 42 Flat mating surface, male component | |
| 44 Angled surface, female component | 45 Draft angle, female component |
| 46 Flat mating surface, female component | 48 Opening in backside of female component |
| 50 Fabric material | 52 Cutout in fabric material |
| 54 External feature (example) | 56 Offset angle |

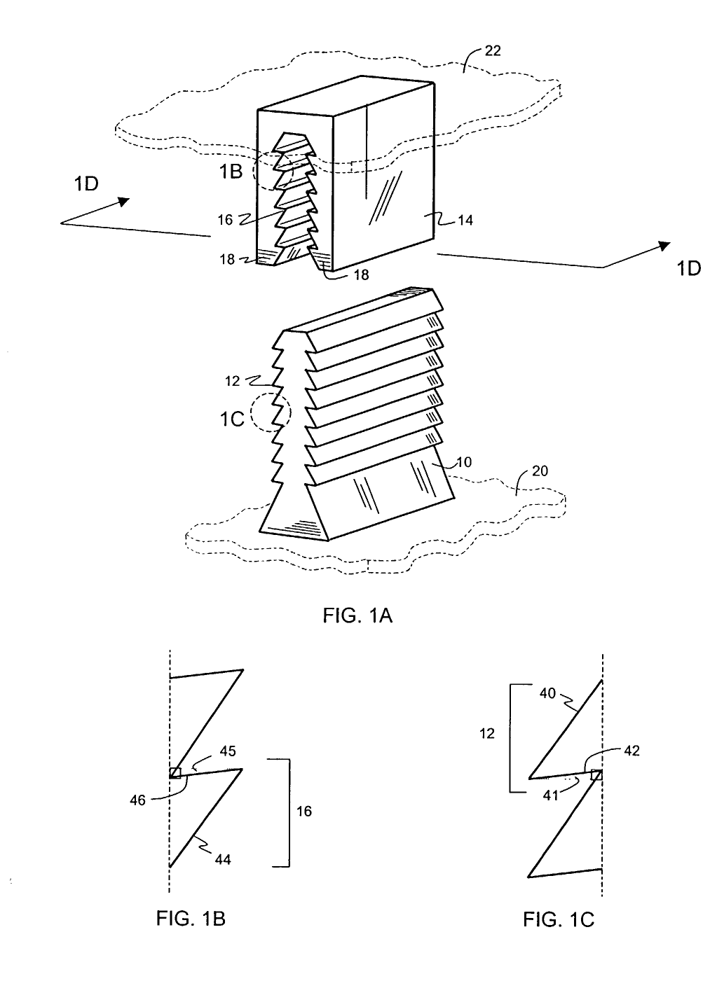

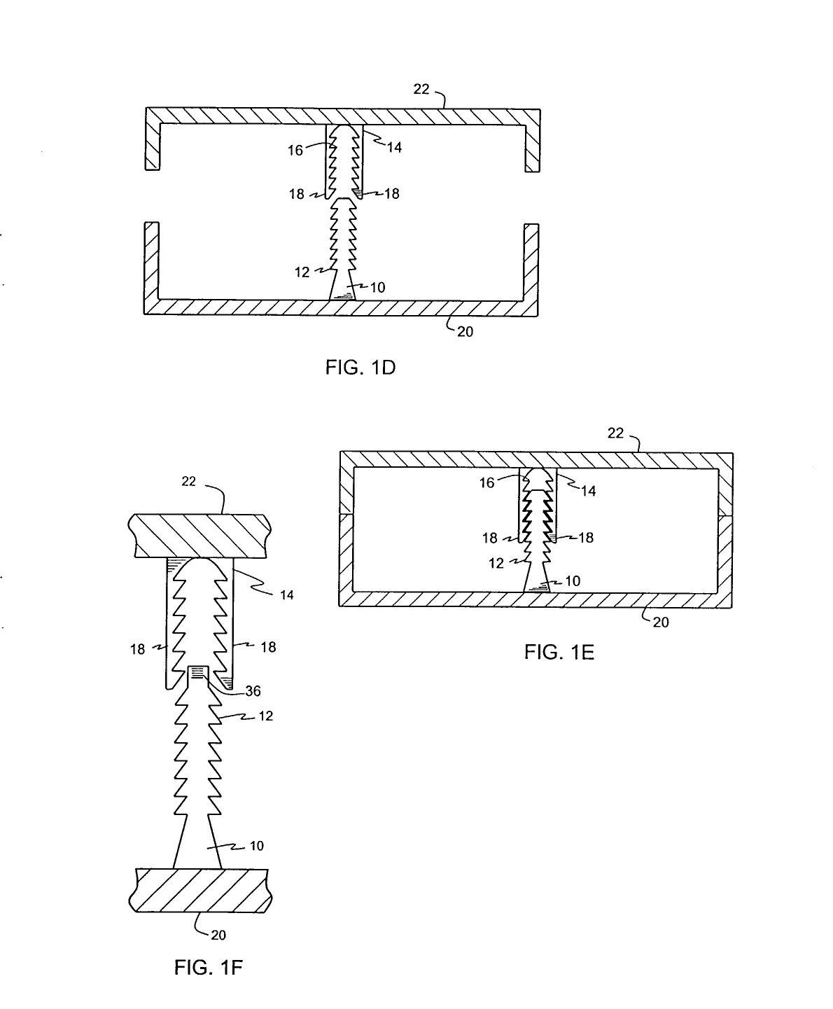

### DESCRIPTION—FIG. 1—PREFERRED EMBODIMENT

A preferred embodiment of the fastener design is illustrated in FIG. 1. FIG. 1A shows a perspective view of the integrally-molded fastener. For clarity, the body halves 20 and 22 are shown in phantom lines in this view only. On the lower body half 20, a flat male rectangular component 10 is formed with a series of parallel ridges or serrations 12 across its width on both sides. The second component 14 is the female counterpart on the complementary upper body half 22, and comprises two flat legs, flanges or prongs 18 with complementary parallel ridges 16 across the width of the inner mating surface of each leg 18. FIG. 1D shows a section cut further illustrating the position of the male component 10 and the female component 14. FIG. 1E illustrates the connection achieved between the male ridges 12 and the female ridges 16 when the surfaces are engaged and mated.

FIGS. 1B and 1C illustrate the triangular ridge details. Using the male ridges of FIG. 1C as typical, the shape of the ridge 12 is triangular with one angled or sloped side 40 and one flat side 42 forming an approximate right angle to allow the components to slide only one way. A small draft angle 41 may be required, depending on the material flexibility as described herein. FIG. 1B illustrates the corresponding female ridge geometry with the angled or sloped side 44, the flat side 46 and the draft angle 45. The number and height of the ridges 12 and 16 depend on application and load-bearing requirements.

### Additional Embodiments

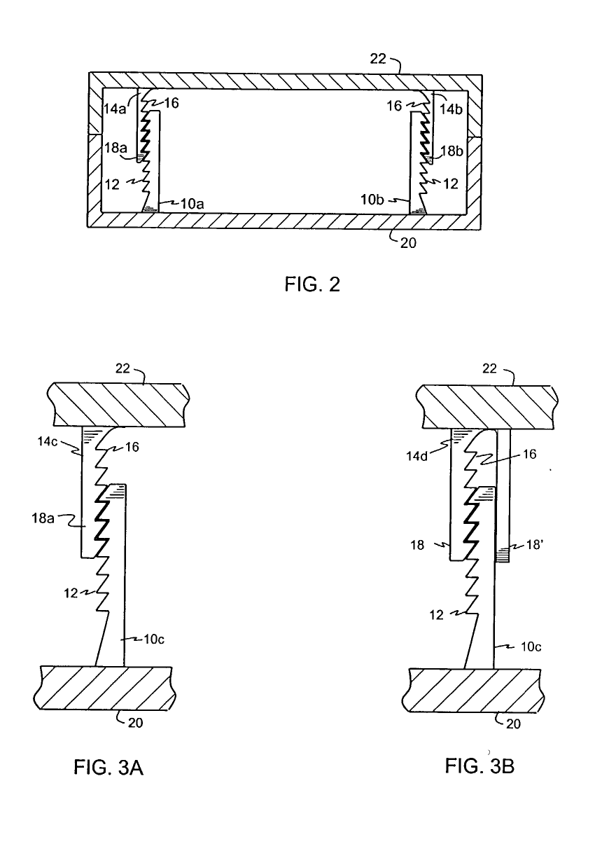

Additional embodiments of the invention are described in further figures. FIG. 2 illustrates a configuration where the male 10 and female 14 components of the fastener are split across the body sections 20 and 22. The male component 10 has been split into a left 10a and right 10b piece, each with ridges 12 on the outward facing mating surfaces only. The female component 14 has been split into a left 14a and right 14b piece, legs 18a and 18b respectively, each with the complementary ridges 16 on the inner facing mating surfaces only.

FIG. 3 shows two possibilities to the single mating surface attachment. In FIG. 3A, the bottom component 10c and the top component 14c have ridges 12 and 16, respectively, only on one surface. In FIG. 3B, the top component 14d maintains a two leg 18 configuration of the preferred female component 14 as originally illustrated in FIG. 1D, but one leg 18 contains ridges 16 while the other leg 18′ does not.

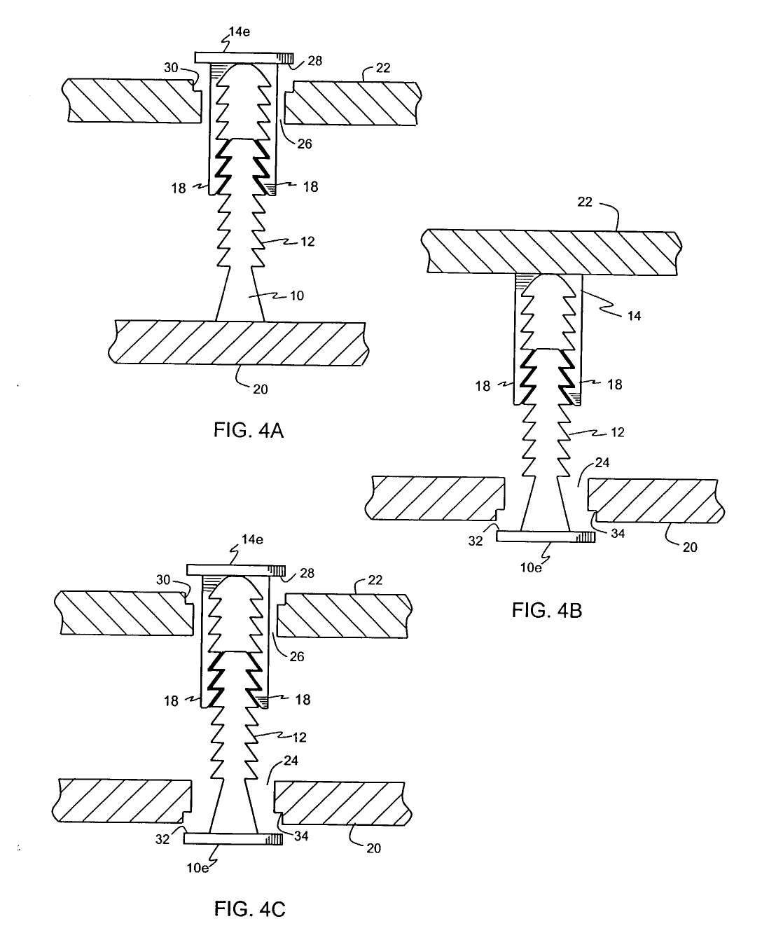

FIG. 4 illustrates possibilities as an externally installed fastener. In FIG. 4A, the female component 14e is an external component. An appropriate hole or opening 26 exists in the upper body half 22 for installation of the female component. In FIG. 4B, the male component 10e is an external component. An appropriate hole or opening 24 exists in the lower body half 20 for installation of the male component 10e. In FIG. 4C, both the female component 14e and male component 10e are external components. Appropriate openings 26 and 24 exist in the upper body half 22 and lower body half 20, respectively, for installation of the components.

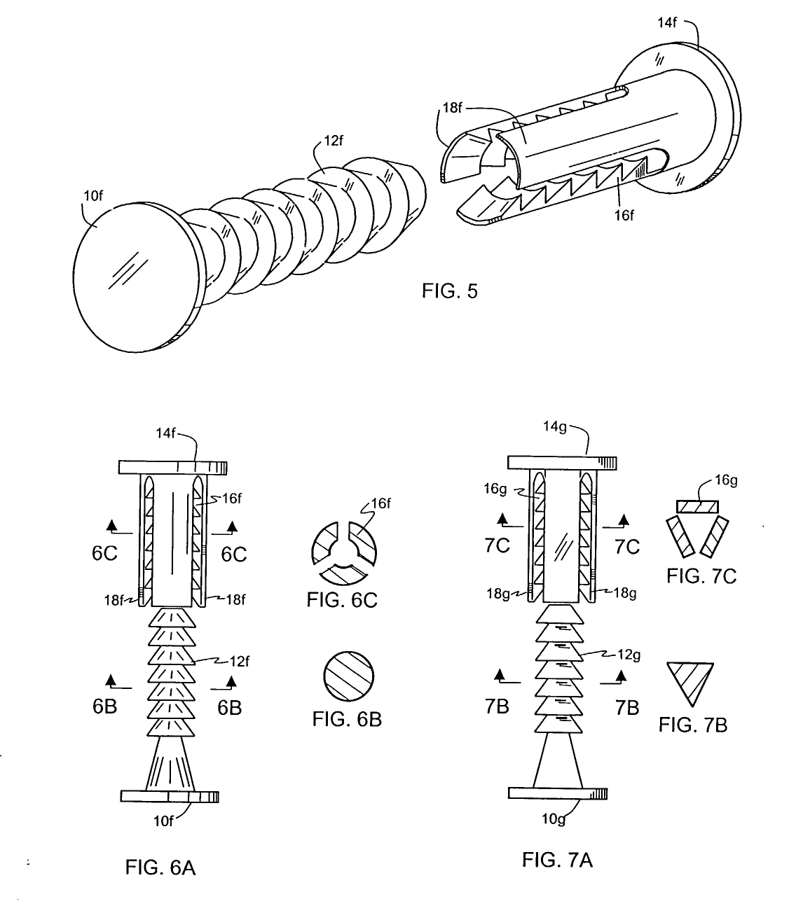

FIG. 5 illustrates a round external fastener design. The male component 10f has radially concentric ridges 12f. The female component 14f has a complementary cross-sectional shape and a plurality of legs 18f with complementary ridges 16f on the inner mating surfaces.

FIGS. 6A, 6B and 6C show a side view and cross-sectional views of the round fastener concept illustrated in FIG. 5. This view shows the fastener as an external concept, but is not limited to that design.

FIGS. 7A, 7B and 7C show a triangular cross-section fastener concept. This view shows the fastener as an external concept, but is not limited to that design. The male component 10g has concentric ridges 12g in a triangular arrangement. The female component 14g has a complementary cross-sectional shape and a triangular arrangement of legs 18g with complementary ridges 16g on the inner mating surfaces.

FIGS. 5, 6 and 7 illustrate possible geometric configurations, but embodiments are not limited to round and triangular shapes.

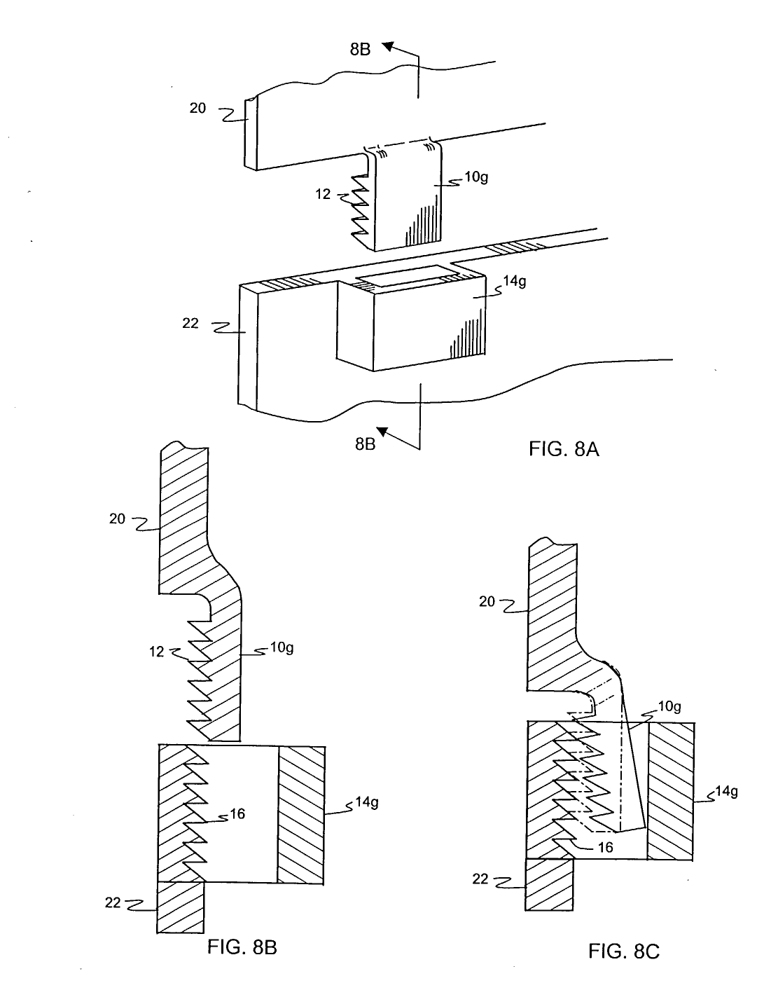

FIG. 8A illustrates an embodiment whereby the male 10g and female 14g components are located along the edge of the body halves 20 and 22. FIG. 8B shows a cross-section view of this configuration to indicate the internal design.

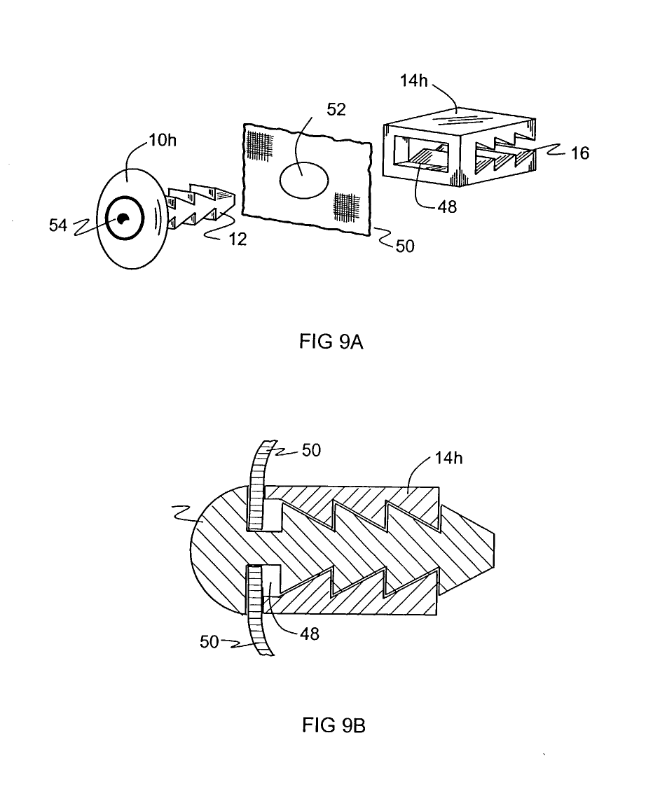

FIG. 9 depicts an embodiment whereby a component is attached to a soft material such as a fabric. This scenario could occur on a stuffed toy, for example, such as attaching an eye component. FIG. 9A shows a perspective view of such an attachment. The fabric piece 50 is sandwiched between the male component 10h and the female component 14h.

### Operation—FIGS. 1, 2, 3, 4, 5, 8, 9, 10

Permanent attachment is achieved in FIG. 1D when the two body halves 20 and 22 are aligned and mated. Engagement occurs as the male 10 component is inserted into the female 14 component, the legs 18 flex slightly outward to allow passing of the male ridges 12. The maximum flexure would occur at the coincidence of the peak heights of ridges 12 and 16 as they slide over each other. The ridges 12 and 16 would slide over each other in ratchet fashion and overlap until complete mating of the body halves 20 and 22 was accomplished as shown in FIG. 1E.

The male ridges 12 and female ridges 16 are complementary and congruent in size to produce an essentially stress-free attachment when engaged and overlapped in the final position. The nominal widths of the male 10 and female 14 components are fundamentally the same. The nominal width of the male component 10 is defined as the minimum dimension in the cross-sectional view, which occurs at the valley of the ridge 12. The nominal width of the female component 14 is defined as the minimum gap between the legs 18, which occurs at the peak of the ridges 16. If the nominal width of the female component 14 is equal to or slightly greater than the nominal width of the male component 10, the female component 14 will not be under residual stress when in the final position. As the nominal width of the female component 14 increases beyond equality with the nominal width of male component 10, the contact surface area decreases and further decreases the load-carrying ability. Final attachment strength of the joint is predetermined by the number of ridges 12 and 16 and the width of the ridges that overlap. Although attachment can be accomplished with one overlap of ridge 12 and 16, the size of the ridge would be larger than when using a greater number of overlapped ridges 12 and 16. More significantly, multiple overlap of the ridges 12 and 16 provides a redundancy not available with a single overlap.

Generally, the male and female flat surfaces, 42 and 46 respectively, that provide the contact surfaces for load bearing are at an approximate right angle to the main axis of the component. Since material flexibility is a key attribute for installation, it is equally important that material flexure does not allow the contact surfaces to slip apart during high load application. A small draft angle 41 and the complementary angle 45 may be required to insure integrity of the contact.

Once the first ridge 12 and 16 engage, pass over each other and overlap, an intermediate attachment has occurred. If an assembly process requires a prefit before any level of attachment, the end of the male component 10 can be elongated to provide an alignment tab 36 as shown in FIG. 1F. This would allow the two body halves 20 and 22 to be aligned and checked prior to intermediate or complete attachment.

FIG. 2 shows the split component configuration. As the body halves 20 and 22 are assembled, the ridges 12 and 16 overlap as previously discussed for FIG. 1. The configuration shown in FIG. 2 still maintains double mating surface attachment through legs 18a and 18b contacting 10a and 10b respectively, even though the mating surfaces of the components are split.

FIG. 2 suggests an alternative embodiment of a single mating surface attachment. Although not preferred, a single mating surface attachment may be appropriate by configuration or loads on the fastener. FIG. 3 further shows two possibilities to the single mating surface attachment. In FIG. 3A, the bottom component 10c and the top component 14c have ridges 12 and 16, respectively, only on one surface. Geometrically, there must be an additional location of support in the structure to maintain lateral contact between the mating surfaces. FIG. 3B shows an example of support. The top component 14d maintains a two leg 18 configuration of the preferred female component 14 as originally illustrated in FIG. 1. One leg 18 contains ridges 16 while the other leg 18′ does not. Leg 18b does provide lateral support to the bottom male component 10c. Conceivably, there are many alternative methods of providing support. The prerequisite is maintaining superior contact of the mating surfaces.

FIG. 4 illustrates applications whereby the fastener is externally installed. This method may be required when a prefit or check is required prior to permanent attachment. FIG. 4A shows the combination of a female component 14e as external and the male component 10 integrally molded into the body half 20. The female component 14e is installed through an appropriate opening 26 in the body half 22. A lip 28 on the head of the female component 14e would provide correct vertical depth when fully seated against the body half 22. If desired, a countersunk groove 30 complementary to the lip 28 would provide a flush external surface. FIG. 4B shows the combination of a male external component 10e and an integrally molded female component 14 in the body half 22. The male component 10e is installed through an appropriate opening 24 in the body half 20. The lip 32 on the head of the male component 10e would provide correct vertical depth when fully seated against the body half 20. A flush external surface is possible as previously described with a countersunk groove 34 complementary to the lip 32. FIG. 4C depicts an external male 10e and female 14e component. The components are installed through the appropriate openings 24 and 26 in the body halves 20 and 22, respectively. In all of the examples, the length of the components and the overlap would be predetermined.

FIG. 5 illustrates a round external fastener design that relies on a plurality of legs 18f to attach to the male component 10f. This type of design utilizes a smaller contact area than the preferred embodiment, which has a continuous surface and can have the overall length increased to meet load requirements. In addition, this design may be more flexible than other configurations based on the lesser mass of material used in each leg. It is critical, therefore, that the contact area be maintained during loading. Use of a draft angle 41 and the complementary angle 45, as depicted in FIGS. 1C and 1B should be considered for such applications where materials and/or design provide potential flexure during loading.

Configurations shown in FIGS. 6 and 7 operate in similar fashion to FIG. 5.

FIG. 8A depicts an embodiment whereby the attachment components are located along the edge of the body halves. The male component 10g has the ridges 12 on one side, facing outward on the upper body half 20. The female component is molded into the lower half 22 and has the complementary ridges 16 on the outer side. FIG. 8B shows a cross-section detail. FIG. 8C shows a similar cross-sectional view but depicts installation of the male and female components. Material flexure of the male component can only occur inside the female component 14g. Therefore, the female component has a space allowance for adequate flexure. This embodiment also requires that additional attachment components are located on the opposite side of the body housing. The one-side attachment design is similar to that shown in FIG. 2 and requires opposing outward force to maintain the attachment contact.

FIG. 9 depicts an embodiment whereby a component is attached to a soft material such as a fabric. This scenario could occur on a stuffed toy, for example, such as attaching an eye component. FIG. 9A shows a perspective view of such an attachment. The fabric piece 50 is sandwiched between the male component 10h and the female component 14h. The male component 10h has a surface feature 54, in this example an eye-shape, that is intended to remain external. The male component 10h is inserted through a cut-out hole 52 in the fabric 50 piece and inserted into the female component 14h through a hole 48 from the opposite side, or backside surface, than shown in other embodiments. A cross-section of the full installation, as depicted in FIG. 9B, shows fabric 50 sandwiched between the male component 10h and the backside of the female component 14h, retaining the external feature of the male component with an internal backside attachment.

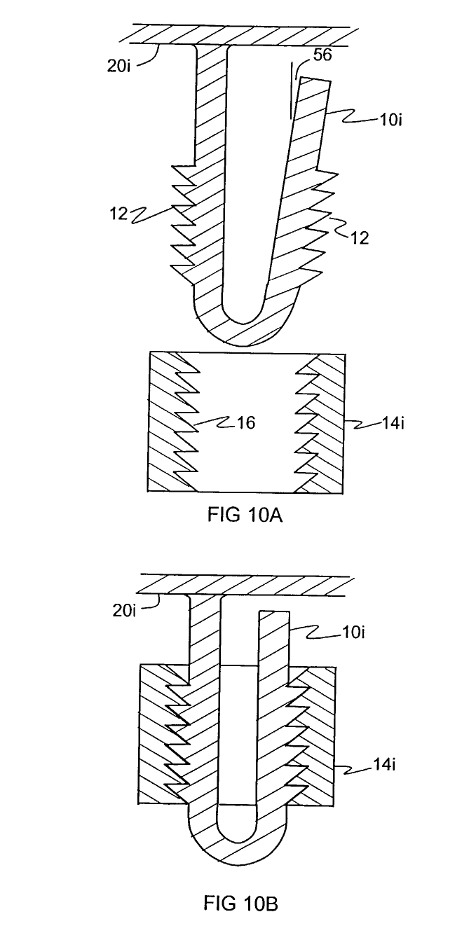

FIG. 10 depicts an embodiment whereby a flexible U-shaped plastic is used to manifest the outward attachment force. FIG. 10A shows the U-shaped male component 10i and the female component 14i. The U-shaped component is attached to body half 20i and has one side at an angle 56 offset to the vertical. In actual practice, both sides could be offset if this was used as an external fastener rather than integral as depicted in this figure. As the component 10i is inserted into 14i, the offset side flexes inward until it is vertical and firmly seated. FIG. 10B illustrates the final position of the components 10i and 14i.

I claim:

1. A fastener for permanent internal attachment comprising:
(a) a male component having a plurality of parallel spaced angled ridges, and
(b) a female component having a plurality of parallel complementary angled ridges
(c) a means for flexure
(d) said ridges of said male and female components are perpendicular to the direction of attachment of two bodies and said ridges are shaped to provide a means of one-way entrapment and prevent a reversal motion during engagement when said male component is inserted into the female component to connect said bodies.

2. The fastener in claim 1 wherein said male component is internally located within said bodies.

3. The fastener in claim 2 wherein said male component is fabricated integrally within one said body or further including insertion within said body.

4. The fastener in claim 1 wherein said male component can be flat, round, triangular or any other shape.

5. The fastener in claim 1 wherein said female component is internally located within said bodies.

6. The fastener in claim 5 wherein the said female component is fabricated integrally within complementary said body or further including insertion within said complementary body.

7. The fastener in claim 1 wherein said female component can be flat, round, triangular or any other shape.

8. The fastener in claim 1 wherein said means of flexure of said female or said male component is arranged to provide minor temporary movement caused by coincidence of said ridges during the insertion of said male component into said female component.

9. The fastener in claim 1 wherein said ridges are triangular shaped in cross-section at a predetermined height, predetermined slopes and numbered at a predetermined pitch to provide the said means for one-way entrapment.

10. The fastener in claim 9 wherein said ridges on said female component are similar in height, slope and number and complementary in shape to said ridges of said male component.
Whereby two body halves are integrally and permanently attached.

11. A fastener for permanent internal attachment of separate elements comprising:
(a) a male component having a plurality of parallel spaced forwardly facing chamfered projections,
(b) a female component having a plurality of parallel complementary facing chamfered projections,
(c) a means for flexure,
(d) said projections are geometrically shaped to provide a means of one-way entrapment and prevent a reversal motion during engagement when said male component is inserted into the female component to connect said separate elements or bodies. The said projections of said male and female components are perpendicular to the direction of attachment of said separate elements or said bodies

12. The fastener in claim 11 wherein said male component is located internally within said bodies.

13. The fastener in claim 12 wherein said male component is integrally constructed within one said body or further externally inserted within said body.

14. The fastener in claim 11 wherein said male component can be flat, round, triangular or any other shape.

15. The fastener in claim 11 wherein said female component is located internally within said bodies.

6. The fastener in claim 15 wherein the said female component is integrally constructed within complementary said body or further externally inserted within said complementary body.

17. The fastener in claim 11 wherein said female component can be flat, round, triangular or any other shape.

18. The fastener in claim 11 wherein said means of flexure of said female or said male component is arranged to provide minor transient movement caused by maximum coincidence of said projections during the insertion of said male component into said female component.

19. The fastener in claim 11 wherein the said projections are triangular shaped in cross-section at a predetermined height, predetermined slopes and numbered at a predetermined pitch to provide the said means for one-way entrapment

20. The fastener in claim 19 wherein said projections on said female component are similar in height, slope and number and complementary in shape to said projections of said male component.
Whereby two body halves are integrally and permanently attached.
